(19) United States
(12) Patent Application Publication
(10) Pub. No.: US 2009/0016805 A1
(43) Pub. Date: Jan. 15, 2009

(54) COSMETICS CASE

(76) Inventor: Young-Kwang BYUN, Seoul (KR)

Correspondence Address: BIRCH STEWART KOLASCH & BIRCH, PO BOX 747, FALLS CHURCH, VA, 22040-0747, US

(21) Appl. No.: 12/147,349

(22) Filed: Jun. 26, 2008

(30) Foreign Application Priority Data
Jul. 9, 2007 (KR) 10-2007-0068732

(51) Int. Cl. B43K 5/06; A46B 11/04; A47L 13/22

(52) U.S. Cl. 401/277; 401/175; 401/172; 401/279

(57) ABSTRACT

Provided is a dischargeable cosmetics case. In the cosmetics case, upon forward rotation of a lower case body, an on/off valve is pushed up and a through hole is opened to discharge the liquid cosmetics to a brush. Inversely, upon reverse rotation of the lower case body, the on/off valve goes down and the through hole is closed to stop discharging the liquid cosmetics, thus freely controlling a discharge/non-discharge of the liquid cosmetics and preventing its outflow or leakage.

### BACKGROUND OF THE INVENTION

1. Field of the Invention

The present invention relates to a dischargeable cosmetics case configured to store liquid cosmetics and forcibly discharge the liquid cosmetics on need. More particularly, the present invention relates to a dischargeable cosmetics case in which, as a piston installed within a lower case body constituting the cosmetics case descends riding a screw rod while applying a pressure to the interior of the lower case body upon forward rotation of the lower case body, an on/off valve inserted and installed in a top inside hole provided inside at a top of the screw rod is pushed up and a through hole is opened to discharge the liquid cosmetics stored in the lower case body by a predetermined amount to a brush via a liquid transfer pipe passing through a perpendicular hole, the through hole, and the top inside hole and inversely, upon reverse rotation of the lower case body, the on/off valve goes down and the through hole is closed to stop discharging the liquid cosmetics, thus freely controlling a discharge/non-discharge of the liquid cosmetics as well as preventing an outflow or leakage of the liquid cosmetics.

2. Description of the Related Art

A conventional dischargeable cosmetics case for liquid cosmetics is disclosed in Korean Patent Application No. 2005-0095350 earlier filed on Oct. 11, 2005 by this applicant. The conventional cosmetics case is configured to include a lower case body 10, an upper case body 20 coupled with the lower case body 10, and a cap 60 coupled to a top of the upper case body 20. In the conventional cosmetics case, a brush 50 is exposed to the exterior through an inner opening 23 of the upper case body 20. A discharge port 40 has a liquid transfer pipe 41 and a fitting part 43 and is fitted and coupled to a bottom of the brush 50. A screw rod 30 is screw coupled with a piston 36 and is fitted and coupled at its top to the fitting part 43 that is formed at a bottom of the discharge port 40. The screw rod 30 is installed within the lower case body 10.

In the conventional cosmetics case 1 as shown in FIG. 5, as the piston 36 installed within the lower case body 10 constituting the cosmetics case 1 descends riding the screw rod 30 while applying a pressure to the interior of the lower case body 10 upon forward rotation of the lower case body 10, a check valve 31a inserted and installed in a top inside hole 31 provided inside at a top of the screw rod 30 is pushed up and a through hole 32 is opened to discharge liquid cosmetics 3 stored in the lower case body 10 by a predetermined amount to a brush 50 through a liquid transfer pipe 41 constituting a discharge port 40, passing through a perpendicular hole 33 provided inside the screw rod 30, the through hole 32, and the top inside hole 31. Inversely, upon absence of rotation of the lower case body 10, the interior pressure of the lower case body 10 decreases, the check valve 31a is restored to an original state by a resilient force of a spring 31b that is inserted and installed in the top inside hole 31, and the through hole 32 is closed to stop discharging the liquid cosmetics 3. In brief, the conventional liquid cosmetics case 1 can freely control a discharge/non-discharge of the liquid cosmetics 3 by allowing the piston 36 to descend riding the screw rod 30 while applying a pressure to the check valve 31a upon rotation of the lower case body 10, thus opening the through hole 32.

However, the conventional cosmetics case 1 has a drawback in that even after a user stops rotating the lower case body 20 and discharging the liquid cosmetics for make-up, the liquid cosmetics flow out little by little until before the internal pressure of the lower case body 20 is completely removed.

Also, because the resilient force of the spring 31b inserted and installed in the top inside hole 31 decreases due to a long-time use, the check valve 31a cannot make the through hole 32 properly airtight, causing the occurrence of a minute aperture. Thus, the conventional cosmetics case 1 has a drawback in that the liquid cosmetics continuously flows out little by little from the minute aperture even after a user stops discharging the liquid cosmetics.

Also, the conventional cosmetics case 1 has a drawback in that the liquid cosmetics flow out and contaminate or spoil the surroundings when the cosmetics case 1 suffers a slight external impact or pressure or is inversed in position.

### SUMMARY OF THE INVENTION

An aspect of exemplary embodiments of the present invention is to address at least the problems and/or disadvantages and to provide at least the advantages described below. Accordingly, an aspect of exemplary embodiments of the present invention is to provide a cosmetics case configured to install an on/off valve within a top inside hole of a screw rod installed inside a low case body constituting the cosmetics case, perpendicularly move up/down the on/off valve upon forward/reverse rotation of the screw rod, and open/close a through hole, thus freely controlling a discharge/non-discharge of the liquid cosmetics as well as preventing an outflow or leakage of the liquid cosmetics.

According to one aspect of the present invention, there is provided a dischargeable cosmetics case configured to have an upper case body formed to fit a brush, a lower case body in which a screw rod screw coupled with a piston is installed and which is coupled to a bottom of the upper case body, and a cap coupled to a top of the upper case body. The cosmetics case includes a liquid transfer pipe, a brush, a fitting part, a perpendicular movement groove, a stop ring, an upper fitting part, a perpendicular hole, stop wings, and an on/off valve. The liquid transfer pipe is formed inside at a top of the upper case body. The brush is fitted to the liquid transfer pipe. The fitting part is formed inside at a bottom of the upper case body. The perpendicular movement groove is provided inside the fitting part. The stop ring is installed inside at a top end of the lower case body. The screw rod is screw coupled with the piston and is supported and installed in a middle of the lower case body. The upper fitting part is formed inside at a top of the screw rod and has a top inside hole with a screw thread. The perpendicular hole extends and is provided downward in a middle of the screw rod. The stop wings are formed at both sides of a circumference of a bottom end of the upper fitting part and are caught and supported by a stop protrusion formed inside of the stop ring. The on/off valve is coupled and installed in the top inside hole and has guide fragments and a spiral protrusion.

### BRIEF DESCRIPTION OF THE DRAWINGS

The above and other objects, features and advantages of the present invention will become more apparent from the following detailed description when taken in conjunction with the accompanying drawings in which:

FIG. 1 is a perspective diagram illustrating a cosmetics case according to an exemplary embodiment of the present invention;

FIG. 2 is an exploded perspective diagram illustrating a cosmetics case according to an exemplary embodiment of the present invention;

FIG. 3 is a cross section illustrating an assembly of a cosmetics case according to an exemplary embodiment of the present invention;

FIG. 4 is a cross section illustrating a use state of a cosmetics case in which a piston descends according to an exemplary embodiment of the present invention; and

FIG. 5 is a cross section illustrating a conventional cosmetics case.

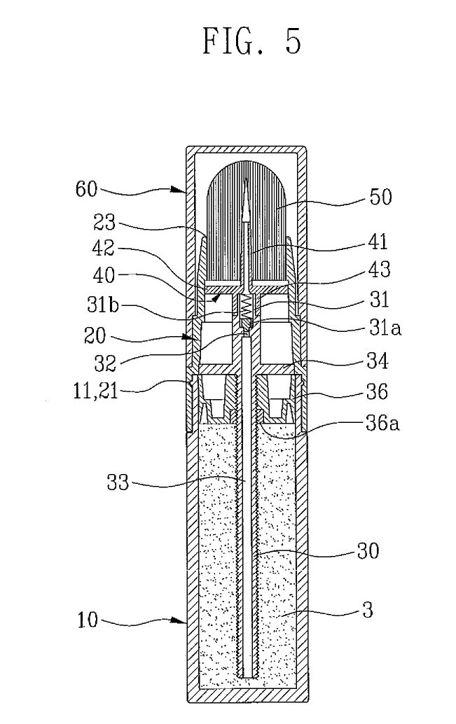

Throughout the drawings, the same drawing reference numerals will be understood to refer to the same elements, features and structures.

### DETAILED DESCRIPTION OF THE INVENTION

Exemplary embodiments of the present invention will now be described in detail with reference to the annexed drawings. In the following description, a detailed description of known functions and configurations incorporated herein has been omitted for conciseness.

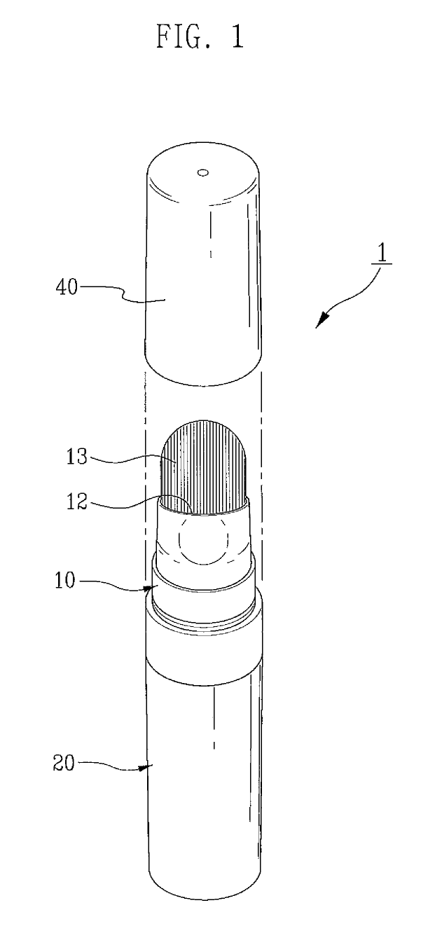

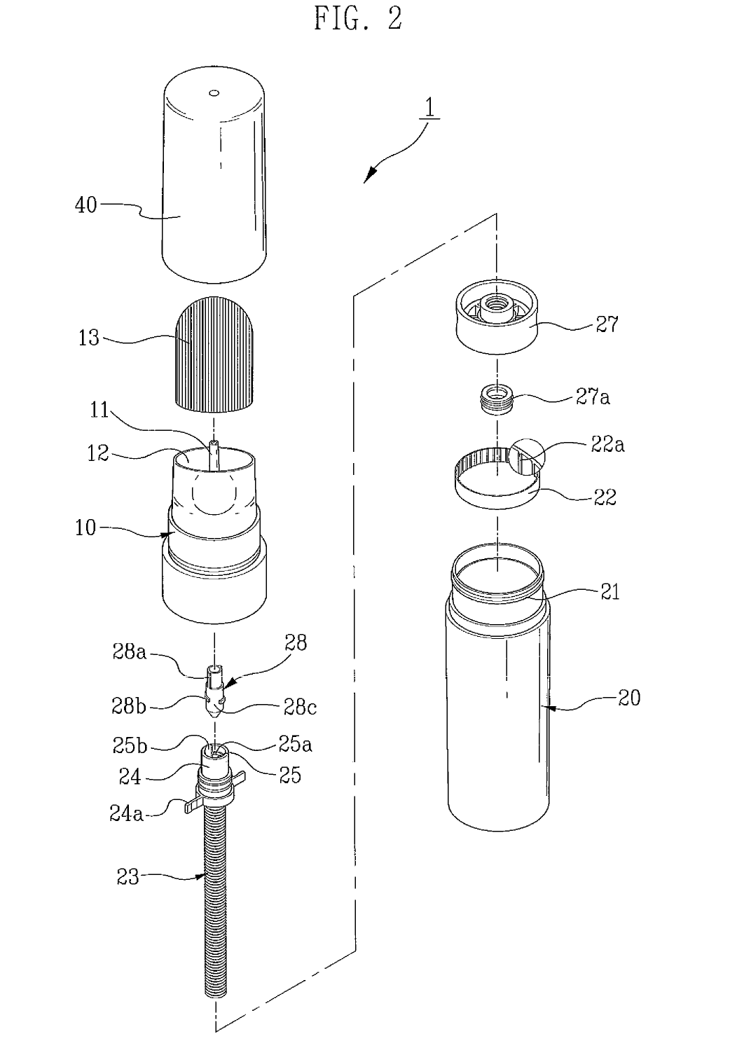

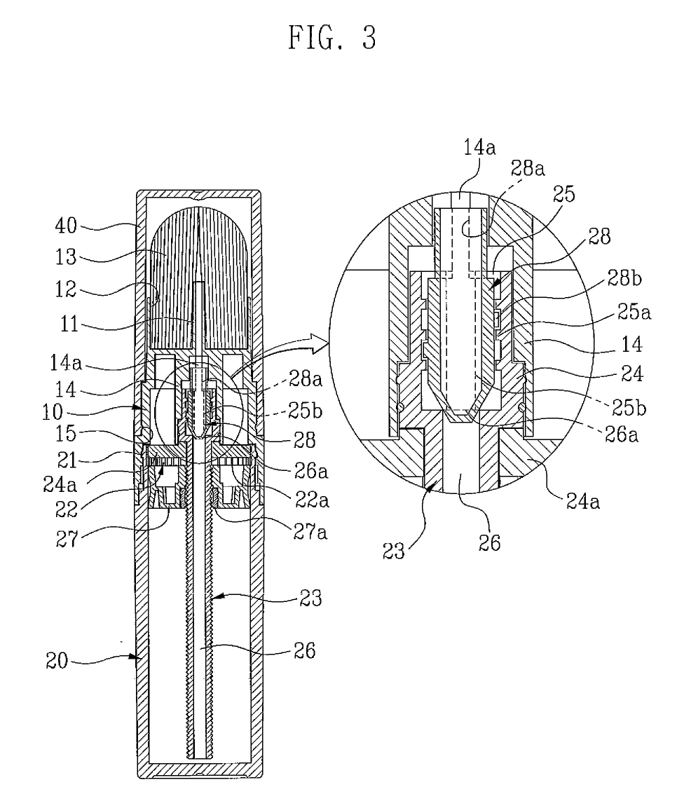

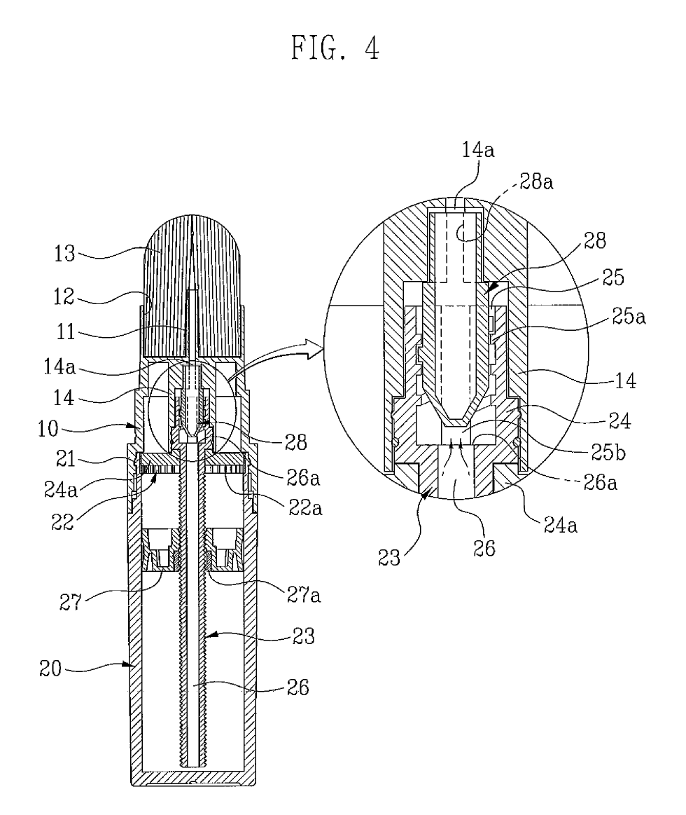

FIG. 1 is a perspective diagram illustrating a cosmetics case according to an exemplary embodiment of the present invention. FIG. 2 is an exploded perspective diagram illustrating the cosmetics case according to an exemplary embodiment of the present invention. FIG. 3 is a cross section illustrating an assembly of the cosmetics case according to an exemplary embodiment of the present invention. FIG. 4 is a cross section illustrating a use state of the cosmetics case in which a piston descends according to an exemplary embodiment of the present invention.

As shown in FIGS. 1 to 4, a liquid transfer pipe 11 is formed inside at a top center of an upper case body 10. A brush 13 is fitted to a brush fitting part 12. A fitting part 14 is formed inside at a bottom center of the upper case body 10. An inward ring 15 is formed at an inner periphery of the upper case body 10.

The fitting part 14 has perpendicular movement grooves 14a at both insides.

The upper case body 10 is fitted and coupled at its bottom with a lower case body 20. The lower case body 20 is of a cup shape closed at its bottom and opened at its top. The lower case body 20 serves as a cylinder and stores liquid cosmetics. The lower case body 20 has an outward protruded ring 21 at its top and outer periphery such that the upper case body 10 freely rotates with being coupled and fixed in position to the lower case body 20 with no release.

The lower case body 20 has a stop ring 22 inside at its top end. The stop ring 22 has a plurality of stop protrusions 22a.

A screw rod 23 is installed inside the lower case body 20 having the stop ring 22. The screw rod 23 is screw coupled with a piston 27. An on/off valve 28 is installed in the screw rod 23.

The piston 27 is screw coupled to a circumference of the screw rod 23 and is tightly fitted and coupled inside the lower case body 20. An ‘O’-ring 27a is fitted and screw coupled inside to a bottom of the piston 27 and keeps the piston 27 airtight.

The screw rod 23 has a screw thread 25a inside at its top. An upper fitting part 24 is formed at one side of the screw rod 23 and has a top inside hole 25 having a perpendicular communication groove 25b. A perpendicular hole 26 communicates with the top inside hole 25 and is extended downward in the middle of the screw rod 23.

Stop wings 24a are formed at both sides around a bottom end of the upper fitting part 24 and provide a tension force. Thus, if the screw rod 23 is installed inside the lower case body 20, the stop wings 24a are caught and supported by the stop protrusions 22a formed inside the stop ring 22.

The stop wings 24a are forcibly fitted to the bottom end of the upper fitting part 24 and are rotated integral with the screw rod 23.

The on/off valve 28 is installed within the top inside hole 25 such that the on/off valve 28 is coupled and installed inside the fitting part 14.

The on/off valve 28 has guide fragments 28a at both sides of its top circumference and has a spiral protrusion 28b with a cut opening 28c at its bottom circumference. The guide fragments 28a are seated in the perpendicular movement grooves 14a provided inside the fitting part 14. The spiral protrusion 28b is screw coupled to the screw thread 25a provided inside the top inside hole 25.

A cap 40 is coupled to a top of the upper case body 10 that is coupled with the lower case body 20.

Regarding a substantial use state, operation of the cosmetics case of the present invention is described below.

Initially, the cosmetics case is assembled and constructed as shown in FIG. 3. The lower case body 20 stores a proper amount of liquid cosmetics. The upper case body 10 has the brush 13 and installs the screw rod 23 therein. The inward ring 15 of the upper case body 10 connects to the outward protruded ring 21 of the lower case body 20. Thus, the upper case body 10 is rotatably coupled integral with and the lower case body 20.

Together with this, the piston 27 is fitted and coupled to the screw rod 23. If so, rotation is suppressed and position is fixed because the stop wings 24a formed at both sides of a circumference of the screw rod 23 are supported and caught by the inside of the stop ring 22 provided inside the lower case body 20.

Accordingly, when a user intends to use liquid cosmetics for make-up, he/she opens the cap 40 and then turns the lower case body 20 in one direction with catching the upper case body 10 with one hand and catching the lower case body 20 with other hand. If so, the screw rod 23 coupled with the piston 27 is simultaneously rotated along with the lower case body 20. The screw rod 23 runs idle in a predetermined idle space and stops running idle for a time when the stop wings 24a are caught by the stop protrusion 22a of the stop ring 22. The piston 27 keeps rotating together with the lower case body 20 while moving upward along the screw thread of the screw rod 23.

In other words, the piston 27 is screw coupled at its inner side to the screw rod 23 and is in close contact at its outer circumference with an inner circumference of the lower case body 20. Thus, upon rotation of the lower case body 20, the piston 27 rotates in close contact together while moving riding the screw thread of the screw rod 23.

As the screw rod 23 runs idle, the screw thread 25a of the top inside hole 25 moves up the spiral protrusion 28b of the on/off valve 28, thus moving up the on/off valve 28 inserted and installed in the top inside hole 25. Here, the on/off valve 28 moves up with no rotation because the guide fragments 28a of the on/off valve 28 are seated and fixed into the perpendicular movement grooves 14a.

Upon down movement of the piston 27, a pressure is applied to the interior of the lower case body 20 filled with liquid cosmetics. At the same time, the liquid cosmetics are moved by the pressure to the top inside hole 25 via the perpendicular hole 26 of the screw rod 23 and are discharged out to the brush 13 fitted and fixed to a top of the liquid transfer pipe 11, via the through hole 26a opened by the up movement of the on/off valve 28 and the perpendicular communication groove 25b of the top inside hole 25.

Thus, upon forward rotation of the lower case body 20, the liquid cosmetics are discharged to the brush 13 filled in the lower case body 20, thus enabling a user to make up his/her face.

After a discharge of the liquid cosmetics is finished as above, upon reverse rotation of the lower case body 20, the screw rod 23 coupled with the piston 27 simultaneously rotates along with the lower case body 20. Here, the screw rod 23 performs reverse idling in a predetermined idle space and stops the reverse idling for a time when the stop wings 24a are caught by the stop protrusion 22a of the stop ring 22 and the piston 27 also moves downward along the screw thread of the screw rod 23.

While the screw rod 23 performs the reverse idling, the spiral protrusion 28b of the on/off valve 28 inserted and installed in the top inside hole 25 moves down along the screw thread 25a of the top inside hole 25. Thus, the guide fragments 28a of the on/off valve 28 that are seated and fixed into the perpendicular movement grooves 14a move down with no rotation, thus closing the through hole 26a and stopping discharging the liquid cosmetics.

Thus, upon reverse rotation of the lower case body 20, the piston 27 screw coupled to the screw rod 23 reverse rotates while making the interior of the lower case body 20 vacuous. At the same time, the on/off valve 28 moves downward to the top inside hole 25 and closes the through hole 26a, thus preventing an excessive discharge of the liquid cosmetics and an outflow or leakage of the liquid cosmetics.

As described above, the present invention is configured to operate a piston installed inside a lower case body using a jet type screw rod. Thus, the present invention has an effect of freely controlling a discharge/non-discharge of liquid cosmetics, discharging a fixed quantity of the liquid cosmetics by making pressure transmission accurate, and preventing an outflow or leakage of the liquid cosmetics by ensuring the airtightness of the through hole using the on/off valve moving up/down.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A dischargeable cosmetics case configured to have an upper case body formed to fit a brush, a lower case body in which a screw rod screw coupled with a piston is installed and which is coupled to a bottom of the upper case body, and a cap coupled to a top of the upper case body, the cosmetics case comprising:
a liquid transfer pipe formed inside at a top of the upper case body;
a brush fitted to the liquid transfer pipe;
a fitting part formed inside at a bottom of the upper case body;
a perpendicular movement groove provided inside the fitting part;
a stop ring installed inside at a top end of the lower case body;
the screw rod screw coupled with the piston and supported and installed in a middle of the lower case body;
an upper fitting part formed inside at a top of the screw rod and having a top inside hole with a screw thread;
a perpendicular hole extending and provided downward in a middle of the screw rod;
stop wings formed at both sides of a circumference of a bottom end of the upper fitting part and caught and supported by a stop protrusion formed inside of the stop ring; and
an on/off valve coupled and installed in the top inside hole and having guide fragments and a spiral protrusion.
